(19) United States
(12) Patent Application Publication
(10) Pub. No.: US 2008/0163826 A1
(43) Pub. Date: Jul. 10, 2008

(54) Collapsible Bird Structure

(75) Inventors: Adam M. Kellogg, Oconomowoc, WI (US); Dean Krotts, Hartland, WI (US)

Correspondence Address: GODFREY & KAHN S.C., 780 NORTH WATER STREET, MILWAUKEE, WI, 53202, US

(73) Assignee: SportPet Designs, Inc.

(21) Appl. No.: 11/620,129

(22) Filed: Jan. 5, 2007

(51) Int. Cl. A01K 31/08

(52) U.S. Cl. 119/431

(57) ABSTRACT

A collapsible bird structure allows for easy assembly of an enclosure for the housing, nesting, and/or feeding of birds. A fabric outer covering containing a flexible wire is connected to a base to form a bird house. A hole may be provided for ingress and egress of birds.

### BACKGROUND OF THE INVENTION

The present invention relates generally to a bird structure. In particular, the present invention relates to a bird structure which is collapsible, whereby the bird structure may be conveniently transported and easily expanded to provide a nesting or feeding structure for birds.

Historically, structures in which various types of birds can build nests or which are designed for feeding are constructed of rigid materials such as wood, metal or plastic. Such bird houses or feeders cannot be collapsed and therefore cannot be easily transported and/or displayed in convenient locations. For example, if one wishes to use a bird house or feeder in a non-permanent location such as a vacation home or campsite, transporting a large bird house may be inconvenient, as would assembling one that may be in a more compact form upon purchase or after disassembly. Also, these traditional bird houses and feeders may be awkwardly shaped or heavy, and as a result difficult to lift and secure to a tree, pole, or other base object. Many only include a means for hanging the bird house from a tree branch that is sufficient to support the weight, or are specifically designed to be placed in a window. However, it may be desirable to mount it on the trunk of a tree or a pole, especially if at a campsite or other location which does not have the necessary elements for mounting the traditional houses. Traditional houses or feeders may also be difficult to open to allow for re-filling bird feed and/or cleaning. It may be desirable to clean the house or feeder, particularly before it will be transported. This is very difficult if the house or feeder has only a small opening sized for the ingress and egress of birds. Furthermore, traditional structures require a higher shipping or transportation cost to the end user due to the larger, non-collapsible size and shape of the traditional structures.

U.S. Pat. No. 6,024,051 issued to Simantob et al. discloses a collapsible bird house which incorporates a plurality of removable rods and connectors to form the rigid frame of the fabric structure, and a removable rainfly/sunshade. With this arrangement, assembly requires insertion of the small rods into small channels in the fabric and is time consuming and difficult, and mounting of the bird house is taught only by hanging from a rod inserted into the top of the structure. U.S. Pat. No. 6,305,396 issued to Zheng discloses collapsible or foldable tents comprising a number of frame members and fabric material forming the side panels. However, it does not disclose using such a tent for housing or feeding birds, it includes a plurality of foldable frame members, and collapsing the tent requires a number of complicated steps to get the tent to a flat position.

For these reasons, it would be beneficial to have a collapsible bird house or feeder comprised of a lightweight material, making it easy to transport and mount on a variety of base objects. It would also be beneficial for such a bird house or feeder to allow suitable access for placement of bird feed and for cleaning.

### SUMMARY OF THE INVENTION

The collapsible bird structure of the present invention includes a base, a fabric cover supported by a flexible wire, and additional fabric flaps. From a flat, collapsed position, a zipper connects the portions of the fabric together to form an enclosed space for the housing or feeding of birds. Unzipping allows the wire to resume a flat position, and the bird structure can be easily cleaned and transported in the collapsed position. In one embodiment, the bird structure can be mounted to a tree, pole or other such object using tabs attached to the base. A hole in the front cover allows birds to enter and exit the bird house.

In one embodiment, the orientation of the bird structure can be changed such that the base is floor of the structure, providing an area for feeding or observing the birds. An opening in the top for placing bird seed or for cleaning can also have a handle for transporting and mounting the bird house. In another embodiment, a handle may be affixed to tabs attached to the fabric cover. Holes may be located in various locations on the cover and flaps for ingress and egress of birds and observation of the inside of the structure.

Various other features, objects, and advantages of the invention will be apparent to those skilled in the art from the following detailed description, including illustrative examples setting forth how to make and use the invention.

### BRIEF DESCRIPTION OF THE DRAWINGS

FIG. 1 is a perspective view of one embodiment of the present invention shown mounted on a tree;

FIG. 2 is a rear perspective view of the embodiment of FIG. 1;

FIG. 3 is a rear view of the embodiment of FIG. 1 shown with the zipper unzipped and the bird house in a collapsed position;

FIG. 4 is a partial cross-section of FIG. 3, taken generally along the line 4-4 in FIG. 3;

FIG. 5 is a perspective side view of the wire frame within the front cover in one embodiment of the present invention;

FIG. 6 is a perspective view of another embodiment of the present invention; and

FIG. 7 is a perspective view of another embodiment of the present invention.

### DETAILED DESCRIPTION

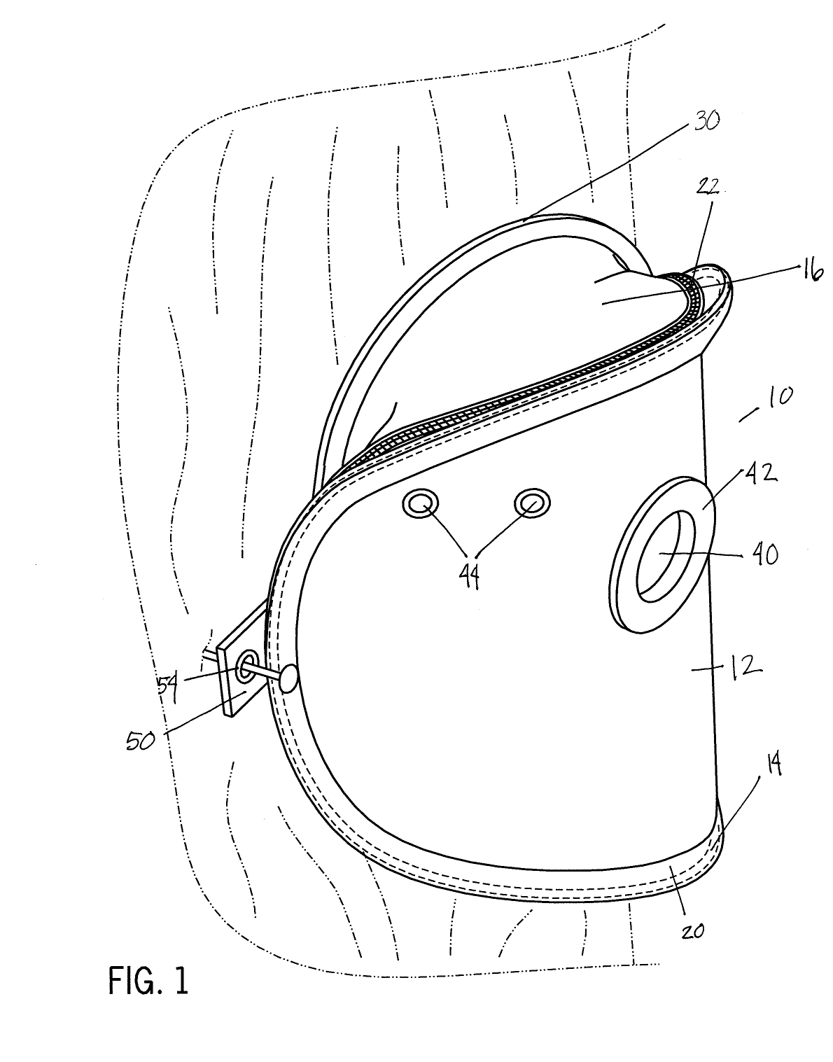

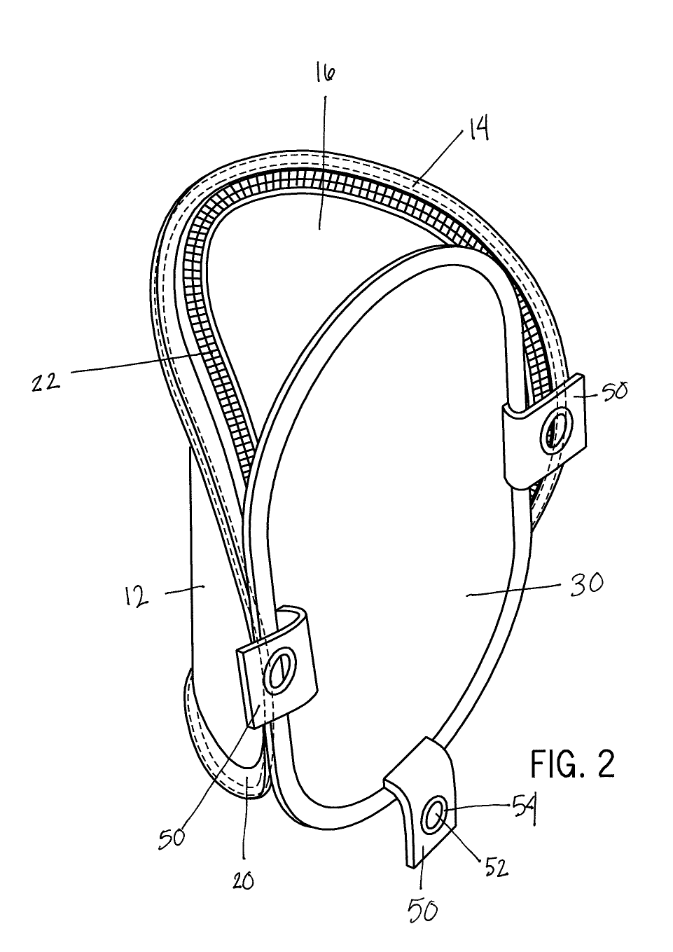

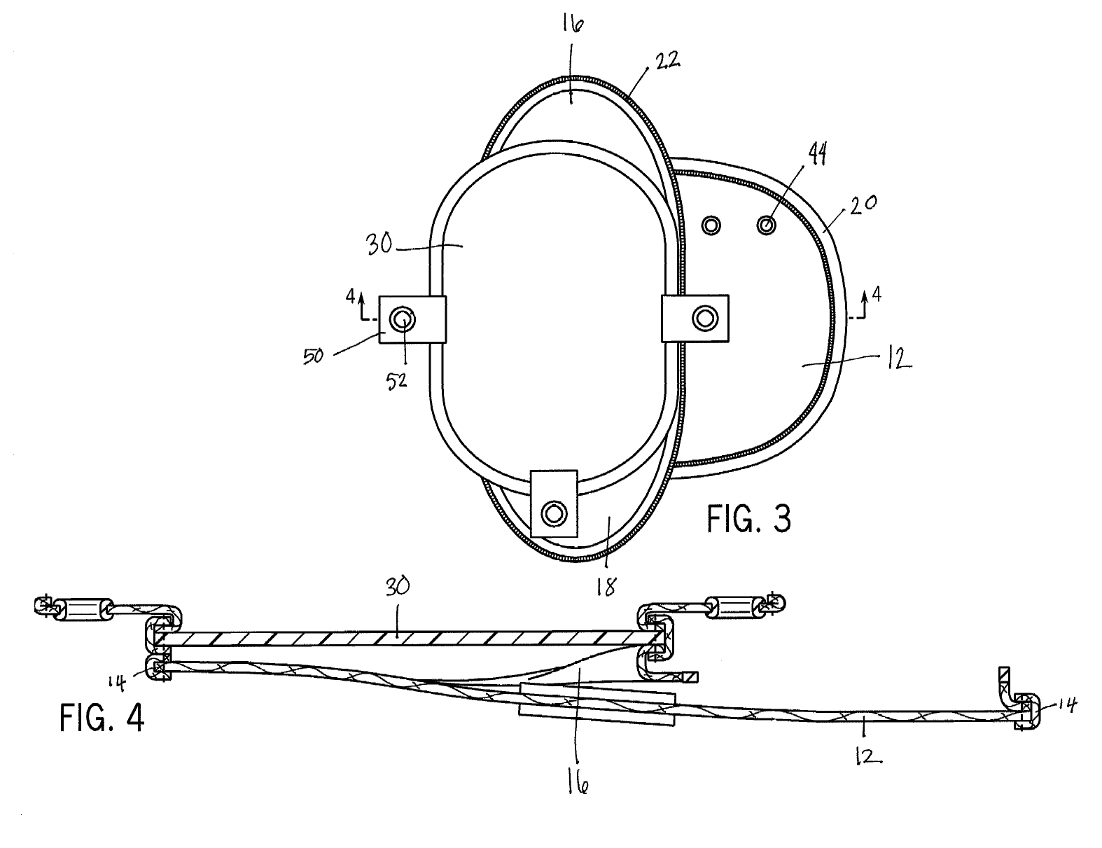

One embodiment of the present invention is the collapsible bird house 10 shown in FIGS. 1-5. The bird house 10 is generally constructed from a front cover 12 that is supported by a flexible wire frame 14, upper and lower flaps 16, 18, and a base 30. The flexible wire 14 is contained in a sleeve 20 attached to the perimeter of the front cover 12. The front cover 12 and sleeve 20 are attached to one side of the base 30. The upper and lower flaps 16, 18 are attached to the perimeter of the upper and lower areas of the base 30. A zipper 22 runs along the perimeter of the front cover 12 that is not attached to the side of the base 30, the perimeter of the upper and lower flaps 16, 18 not attached to the base 30, and the side of the base 30 opposite the attachment of the front cover 12. To assemble the bird house 10 from its collapsed position (FIG. 3) to its expanded position (FIG. 2), the zipper 22 is zipped from its start at the lower attachment point for the front cover 12 and lower flap 18, around the perimeters of the front cover 12, lower flap 18, side of base 30 opposite attachment points, upper flap 16, and ends at the attachment point of the front cover 12 and upper flap 16 to the base 30. To collapse the bird house 10 into a flat position (FIG. 3) from the expanded position (FIG. 2), the zipper 22 is unzipped starting with the upper attachment point around the upper flap 16, front cover 12, opposite side of the base 30, lower flap 18 and ending at the lower attachment point.

In the zipped position shown in FIG. 1, the bird house 10 forms a structure in which birds can nest. The bird house 10 can be constructed in a variety of sizes to allow for the nesting of a variety of birds. For example, a bird house 10 for a small bird like a wren will have smaller overall dimensions than one for a larger bird. The fabric cover 12 and flaps 16, 18 are preferably made of a durable, weather-resistant fabric such as nylon or polyester. The inside of the fabric may contain a coating such as a polyurethane coating to protect from damage by the birds and allow easy cleaning. The base 30 is preferably made of a stiff, durable, weather-resistant material such as plastic. Other suitable materials may also be used to construct the cover 12, flaps 16, 18, and base 30. A hole 40 is cut in the front cover 12 and optionally may be framed with a stiff frame 42. This hole 40 allows for the ingress and egress of birds, and can be sized to allow for smaller or larger birds to pass. Ventilation holes 44 (optional) can be placed in the front cover and upper and lower covers 16, 18 to allow for additional airflow inside the bird house 10.

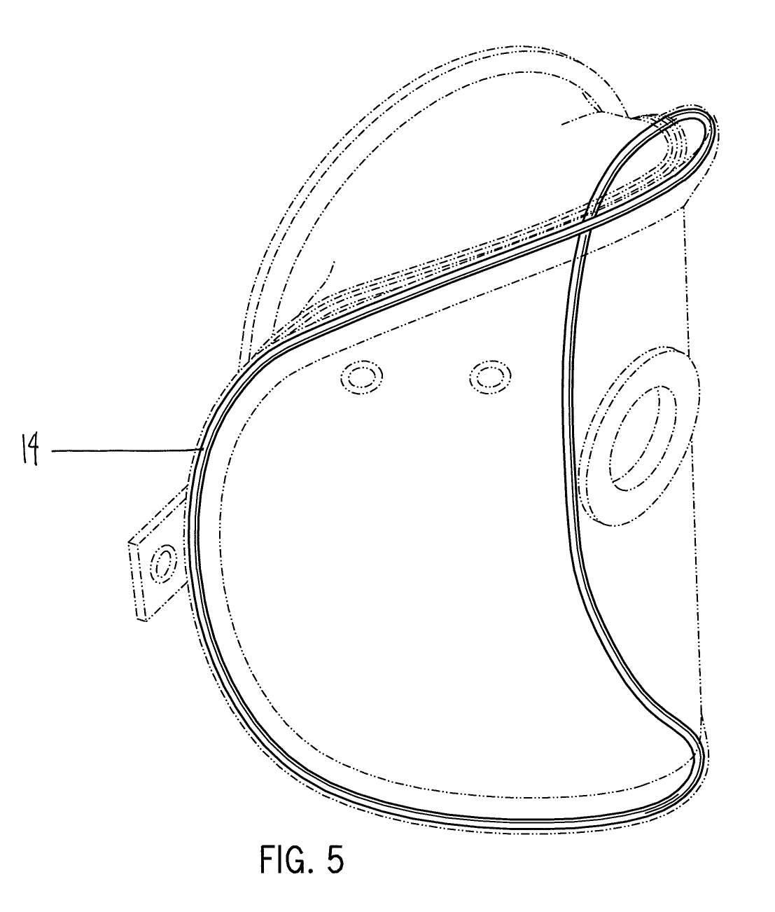

The flexible wire 14 fits around the perimeter of the similarly shaped front cover 12. The wire 14 is affixed to the front cover 12 by fitting into a fabric sleeve 20 that is sewn, friction welded, glued, or otherwise attached to the border of the front cover 12. In the collapsed position shown in FIG. 3, the wire 14 is in a plane parallel to the base 30. When the front cover 12 is folded so that the side of the cover 12 opposite the side the attached to the base 30 meets the side of the base 30 opposite the attachment side, the tension in the wire 14 causes the cover 12 to bow out into an arc shape. The tension on the wire 14 pushing against the sleeve 20 attached to the front cover 14 forms the rigid, curved frame for the front cover 12. The zipper 22 is then zipped to connect the cover to the upper and lower flaps 16, 18 and the base 30, as seen in FIG. 5.

Referring now to FIGS. 1, 2 and 3, the front cover 12 and sleeve 20 containing the wire 14 are sewn or otherwise attached to the base 30 along one side of the base 30. The upper point of the attachment is also the starting point for the zipper 22. The upper and lower flaps 16, 18, which are sewn or otherwise attached to the top and bottom borders of the base 30, contain one side of the zipper teeth, and the perimeter of the cover 12 contains the other side of the zipper teeth. In one embodiment, the upper and lower flaps 16, 18 have attachment points at the upper and lower attachment points of the cover 12 to the base 30 and at the same locations on the opposite side of the base 30. Starting from the collapsed position in FIG. 3, the zipper 22 is zipped starting at the upper attachment point of the front cover 12 and upper flap 16, connecting the cover 12 to the upper flap 16, the cover 12 to the side of the base 30 opposite the attachment, and around to connect the lower flap 18 to the cover 12. The tension from the wire 14 causes the front cover 12, now connected to the flaps 16, 18, to form an arc shape, defining the inside area of the bird house 10.

In the unzipped, collapsed position, as seen in FIGS. 3 and 4, the bird house 10 is in a flat position. As shown in the cross-section in FIG. 4, the front cover 12 is in a generally flat position, with the base 30 collapsed over to lie flat on top of the cover 12. The upper and lower flaps 16, 18 can be pulled out for a more flat overall shape, or folded under the base (not shown) for a more compact shape. The bird house 10 is now in a generally flat shape, and can be easily packaged, transported or stored in a variety of compact spaces. Also, the flat surface of the cover 12 in the collapsed position allows for easy cleaning of the inside surface of the cover 12, and the inside surfaces of the flaps 16, 18 and base 30 can also be easily cleaned in the collapsed position.

As shown in FIGS. 1 and 2, one embodiment of the bird house 10 may also include a plurality of tabs 50 for mounting the bird house 10. The tabs 50 may include holes 52 to allow for nailing the bird house 10 to a tree (as shown in FIG. 1) or through which to thread string or rope or hook a bungee cord for securing the bird house onto a tree or other base structure. The tabs 50 may be made of a durable fabric so that they can be sewn or otherwise affixed to a fabric border on the base. The holes 52 may be reinforced with grommets 54 made of metal, plastic, rubber, etc., so that they may withstand the tension from tying or pulling by bungee cords and the weight of the food and/or nests of birds in the bird house 10.

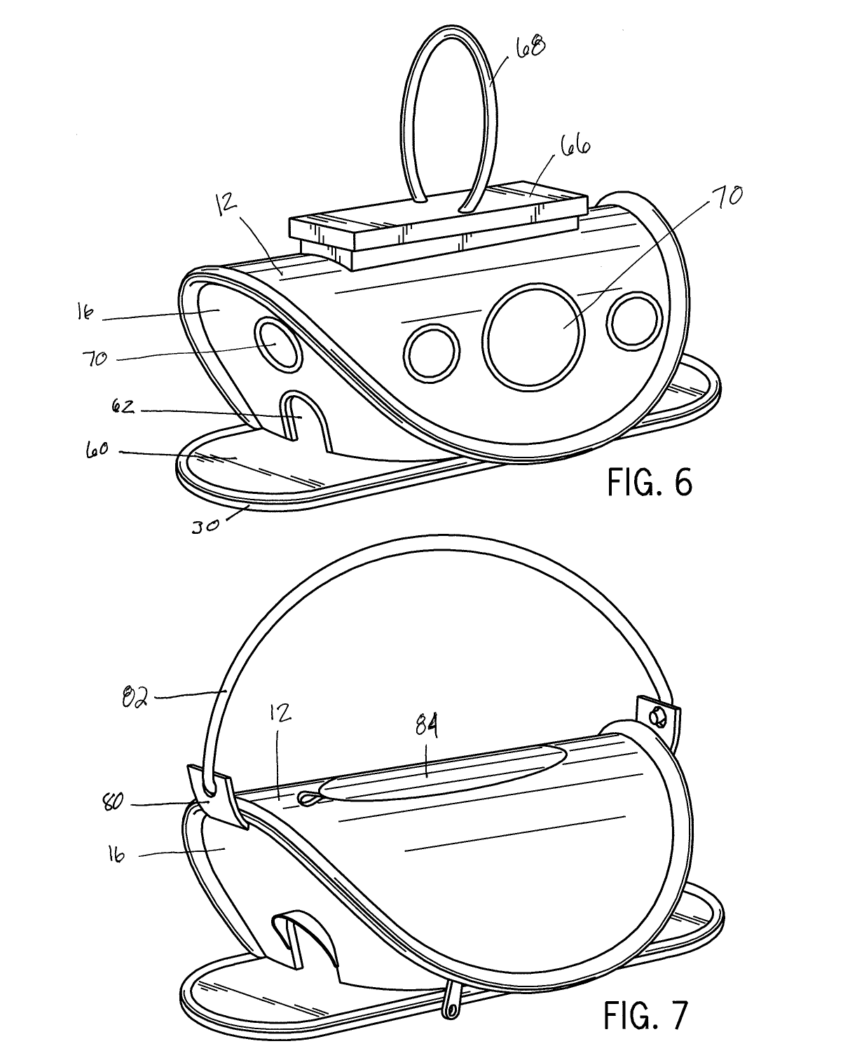

As seen in FIG. 6, another embodiment of the present invention includes a collapsible bird house 10 that can be used for feeding. In this embodiment, the bird house 10 is positioned such that the base 30 is now the bottom of the structure, acting as a floor of the feeder. Such an embodiment may include upper and lower flaps 16, 18 attached to a different location on the base 30 so as to provide a surface 60 on the base 30 for the entry and exit of birds through an opening 62 adjacent to the base 30. Such an embodiment may also include a recess (not shown) in the front cover 12 into which a lid 66 can be removed for easily placing bird seed into the bird house 10. The lid 66 may also include a handle 68 for easy removal and for carrying the bird house 10. As shown in FIG. 6, the front cover 12 and upper and lower flaps 16, 18 may also include a plurality of holes 70 for the ingress and egress of birds or for viewing the inside of the bird house 10.

FIG. 7 shows another embodiment of the collapsible bird house 10 to allow for feeding. Such embodiment may include tabs 80 attached to the front cover 12 through which a handle 82 can be placed for carrying or hanging the feeder. The front cover 12 may include an opening (not shown) with a flap 84 that can be opened for the easy placement of bird feed.

While the invention has been described with respect to certain embodiments, those skilled in the art will appreciate that certain substitutions, alterations, and omissions may be made without departing from the spirit of the invention. Accordingly, the foregoing description is meant to be exemplary only and should not limit the scope of the invention set forth in the following claims.

What is claimed is:

1. A collapsible bird structure comprising:
a base;
a cover with a portion thereof attached to the base, the cover having a perimeter;
a flexible wire secured to the perimeter of the cover, wherein the wire is adapted generally to flex from a collapsed position in which the wire is substantially flattened into a plane to an expanded position in which the wire is in a curved shape;
two flaps attached to and extending from the base; and
wherein flexing the wire from the collapsed position to the expanded position and securing the perimeter of the cover to the flaps and base forms an enclosure.

2. The collapsible bird structure of claim 1 wherein a zipper is attached to the base, cover and
flaps to secure the perimeter of the cover to the flaps and base.

3. The collapsible bird structure of claim 2 further including a hole in the cover sized for the ingress and egress of birds.

4. The collapsible bird structure of claim 3 further including tabs for mounting the bird house.

5. The collapsible bird structure of claim 4 further including at least one hole for ventilation.

6. The collapsible bird structure of claim 1 further including a recess in the front cover.

7. The collapsible bird structure of claim 6 wherein a lid is fitted to the dimensions of the recess.

8. The collapsible bird structure of claim 6 further comprising a handle affixed to the lid.

9. The collapsible bird structure of claim 6 further comprising at least one opening in at least one flap for the ingress and egress of birds.

10. The collapsible bird structure of claim 1 further including an aperture in the front cover.

11. The collapsible bird structure of claim 10 wherein the aperture is formed by unzipping a section of the fabric of the front cover.

12. The collapsible bird structure of claim 10 further comprising a handle affixed to the front cover.

13. The collapsible bird structure of claim 10 further comprising at least one opening in at least one flap for the ingress and egress of birds.
